(19) United States
(12) Patent Application Publication
(10) Pub. No.: US 2024/0279088 A1
(43) Pub. Date: Aug. 22, 2024

(54) MONOCHLORAMINE WATER DISINFECTION SYSTEM AND METHOD

(71) Applicant: Barclay Water Management, Inc., Newton, MA (US)

(72) Inventors: John Gotthardt, Mendon, MA (US); Chunxiao Kong, Medford, MA (US); Richard Traverse, Arlington, MA (US); Caibin Xiao, Holliston, MA (US)

(21) Appl. No.: 18/645,237

(22) Filed: Apr. 24, 2024

Related U.S. Application Data
(63) Continuation of application No. 17/369,700, filed on Jul. 7, 2021.
Application No. 17/369,700 is a division of application No. 14/336,781, filed on Jul. 21, 2014, now abandoned.
(60) Provisional application No. 61/930,891, filed on Jan. 23, 2014.

(51) Int. Cl. C02F 1/68; C02F 1/50

(52) U.S. Cl. CPC C02F 1/686; C02F 1/50; C02F 2209/40; C02F 2303/04

(57) ABSTRACT

A water disinfection system that generates monochloramine through the reaction of a chlorine source, such as sodium hypochlorite, and an ammonium source, such as ammonium sulfate that is intended to be used in the distal ends of a water supply system. The system measures the total water flow rate of the water stream. The system also comprises a controller that controls the feed rate of the chlorine source and ammonium source based on the total water flow rate. The system also comprises various sensors such as an oxidation-reduction potential sensor, a free chlorine sensor and a total chlorine sensor. The system allows simple management of the generation of monochloramine and is particularly suitable for use in commercial or residential buildings.

### CROSS REFERENCE TO RELATED APPLICATIONS

This application is a continuation of U.S. Non-Provisional application Ser. No. 17/369,700, filed Jul. 7, 2021, which is a divisional of U.S. Non-Provisional application Ser. No. 14/336,781, filed Jul. 21, 2014, which claims priority to U.S. Provisional Patent Application No. 61/930,891, filed on Jan. 23, 2014.

### TECHNICAL FIELD OF THE DISCLOSURE

The invention generally relates to water disinfection method, system and apparatus. More specifically, the invention relates to water disinfection system using monochloramine. Even more specifically, the invention relates to monochloramine generating water disinfection system targeted for commercial or residential water supply system.

### BACKGROUND

Monochloramine has been used to treat large public water systems for many years. Monochloramine is generated by a chlorine source and an ammonium source. The chlorine solution and ammonium solution can be injected to the public water distribution system in close proximity or into separate locations to generate monochloramine. The chlorine source could be either chlorine gas or sodium hypochlorite. The ammonium source could be one of the following: ammonia gas, aqueous ammonia solution, or ammonium salt such as ammonium sulfate. The chlorine source and the ammonium source generate monochloramine according to the following chemical equations:

$$\begin{matrix}{NH}_{4}^{+} + NaOCl \to {NH}_{2} Cl + {Na}^{+} + {H}_{2} O \\ {NH}_{3} + HOCl \to {NH}_{2} Cl + {H}_{2} O \\ 2 N {H}_{3} + {Cl}_{2} \to 2 N {H}_{2} Cl\end{matrix}$$

Chlorine or hypochlorite reacts rapidly with ammonium ion in the pH range of 6 to 9. Three reaction products are formed depending on the stoichiometric molar ratio of chlorine to ammonium. At the 1 to 1 molar ratio, the dominating product formed is monochloramine. Dichloramine and trichloramine are formed when the ratio is increased beyond 1. As the ratio approaches to 3, dichloramine and trichloramine become the dominating species, and the total oxidant concentration measured by the traditional DPD method reaches a minimum. This is commonly referred to as the chlorination breakpoint. Normally, only monochloramine is effective at disinfection. Dichloramine and trichloramine are unintended side products that are sometimes harmful.

Monochloramine is effective in killing bacteria such as Legionella. It has been found that hospitals located in municipal region where public water is treated with monochloramine experienced far fewer cases of Legionella related illness. Monochlroamine treatment is normally more effective than chlorine treatment because monochloramine is more stable and can travel to the farther end of a water distribution system without degrading, thereby staying active for a longer period of time. Even though monochloramine can stay active for a relatively long duration, water usually travels a very long distance from the municipal water treatment facility to the end user such as a residential or commercial building. By the time the water reaches the building, often times most, if not all, of the monochloramine from the municipal water treatment would have been depleted.

Referring to FIG. 3, it is a schematic diagram of a domestic water system typical in a building or a group of buildings. The water system consists of a variety of apparatuses and sub-systems. The major apparatuses include pressure boost pumps, back flow preventers, and electronic faucets. An example of a sub-system is a recirculated domestic hot water system supplying hot water throughout the building. The domestic hot water system can also include hot water heaters, heat exchanges, and hot water storage tanks. The distal end of a water supply system commonly refers to the very far end of a water supply system in which water has been travelling a long distance from the original supply point, such as the municipal water treatment facility. The distal end is also sometimes referred to as the point of use because it is often the place where the water meets the users. Showers and faucets at the ends of piping runs are examples of a distal end of a water supply system.

While a large municipal water treatment system can maintain a constant and stable level of monochloramine supply, it may be difficult to guarantee that the water reaching the end user contains a sufficient amount of monochloramine to meet the disinfection goals of the user. This is especially true for domestic hot water systems and for a complex sub-distribution system within a building or a group of buildings. As water is traveling through complex pipes, apparatuses, and sub-systems, monochloramine can be consumed or degraded. It is not uncommon that the concentration of chlorine or monochloramine at the distal end is well below 0.5 mg per liter, which is commonly considered to be the minimal level required for effective disinfection of water against waterborne pathogens. Thus, there is an increasing demand for secondary monochloramine treatment systems at the distal ends of water supply systems.

Theoretically, the secondary treatment in a building can be carried out by adding monochloramine locally in a way similar to how monochloramine is generated in a large municipal level water treatment facility. However, in a public or municipal water distribution system, complicated and specialized infrastructure and professionally trained water treatment personnel are almost always required to safely operate the water treatment system, including the monochloramine generating subsystems. Although monochloramine can be generated in a large municipal water system effectively and reliably, treating domestic water systems with monochloramine has unique challenges.

Unlike a municipal system which is purposefully built with the infrastructure and which has designated water treatment professionals to constantly monitor the system, a domestic secondary monochloramine treatment system typically must be retrofitted within an existing building water system and be operated by layperson such as the building manager. Thus, the operators of the local system will likely lack the specific knowledge to handle, monitor, and control different aspects of water treatment. The operators are also often unqualified to conduct chemical testing of the water sample in the secondary water treatment system. Without the supervision of any water treatment professionals, a complicated secondary treatment system similar to a municipal water treatment facility raises significant safety concerns.

From the foregoing, it will be appreciated that there is a need for a user-friendly monochloramine water treatment system that will act as a secondary water treatment source to be installed in a commercial or residential building. To this end, the secondary water treatment system must be safe and suitable for the use in a commercial and domestic building.

### SUMMARY

The aforementioned needs are satisfied by the monochloramine generating water disinfection system in accordance with the embodiments of the present invention. In one aspect, the embodiments of the present invention provide for on-site water treatment using monochloramine in a system that is able to operate unattended for a period of time. In another aspect, the embodiments of the present invention are easy to install, easy to operate, and economically affordable. The embodiments also automatically generate a desired level of monochloramine and prevent the generation dichloramine and trichloramine. The embodiments also comprise a computerized interface that generates warnings, including real-time warnings and remote warnings such as email or SMS alerts, to the operator of the system when any detected value is outside of the alarm limits.

In some embodiments, the water disinfection system comprises multiple tees, a thermal flow switch, an oxidation-reduction potential (ORP) sensor, a free chlorine sensor, a total chlorine sensor, a pressure transmitter, a flow meter measuring the flow rate of the main water stream, a chlorine pump, an ammonia pump, a mixer, a sample valve, and a programmable controller. The controller controls the chlorine pump and the ammonia pump to inject the chlorine source precursor chemical and ammonium source precursor chemical into the water stream to generate monochloramine at the mixer. The amount of chlorine source and ammonium source injected into the water stream is determined by the controller's calculation based on the total water flow rate and various sensors readings.

In some embodiments, the controller is capable of performing a series of step to control the generation of monochloramine. The controller first receives a reading from the flow meter on the total flow rate of the water stream. The controller then calculates the required amount of chlorine source needed based on the total water flow rate. The controller then directs the chlorine pump to inject sodium hypochlorite into the water system. Once the sodium hypochlorite solution begins to flow through the inline flow meter, the inline flow meter measures the flow rate of sodium hypochlorite and transmits the flow rate in the form of current to the controller. After the controller receives a reading of the flow rate of sodium hypochlorite, it transmits a control signal to the chlorine pump to adjust the power of the chlorine pump until the flow rate measured by the inline flow meter matches the feed rate calculated. The control of the injection of ammonium sulfate is very similar to that of sodium hypochlorite. When free chlorine source is detected in the water stream, the controller subtracts the amount of chlorine to be supplied accordingly.

The amount of ammonium source to be supplied into the water stream can be based on a stoichiometric molar ratio of chlorine to ammonium. Thus, the controller regulates the amount of the chlorine source and the ammonium source at a predetermined range, which often based on a predetermined ratio. In one embodiment, the stoichiometric ratio is maintained approximately at 1:1 to prevent the generation of dichloramine and trichloramine. In some embodiments, the controller also monitors the total chlorine amount and the oxidation potential of the water stream to ensure no abnormality occurs in the system. When any abnormality is detected, the controller provides an appropriate visual or audio indication to the operator to indicate the problem and/or transmit remote warning alerts to the operator via electronic communication, such as e-mail, SMS, and any forms of instant messaging. In a preferred embodiment, the water disinfection system is not required to detect the ammonia level or the monochloramine level. This avoids the need of conducting chemical testing for the system to operate.

### BRIEF DESCRIPTION OF THE DRAWINGS

FIG. 1 is a schematic block diagram illustrating the basic configuration of a monochloramine generating water disinfection system in accordance with some embodiments of the present invention.

FIG. 2 is a schematic block diagram illustrating the basic configuration of another monochloramine generating water disinfection system in accordance with other embodiments of the present invention.

FIG. 3 is a schematic block diagram illustrating a typical residential water supply system.

FIG. 4 is an exemplary flow chart illustrating the operation of the controller in controlling the generation of monochloramine in accordance with some embodiments of the present invention.

### DETAILED DESCRIPTION OF EMBODIMENTS

The following discussion addresses a number of embodiments and applications of the present disclosure, reference is made to the accompanying drawings that form a part hereof, and are shown by way of illustration of specific embodiments in which the disclosure may be practiced. It is to be understood that other embodiments may be utilized and changes may be made without departing from the scope of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Finally, many of the steps are presented below in an order intended only as an exemplary embodiment. Unless logically required, no step should be assumed to be required earlier in the process than a later step simply because it is written first.

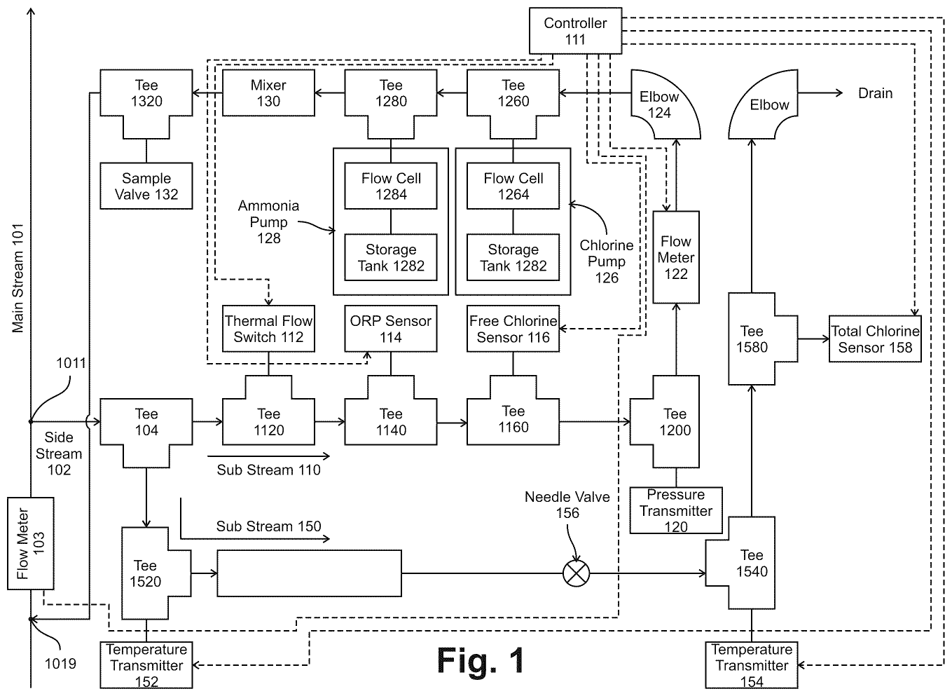

Referring now to FIG. 1, it is a schematic block diagram of a distal end water system 100 with a monochloramine water disinfection system installed in accordance with some embodiments of the present invention. The water system 100 can be incorporated into any water system or subsystem, such as any water system in a residential or commercial complex. The water system 100 comprises a main carrier water stream 101 and a side stream 102. The side stream 102 partially diverges water from the main stream 101 at point 1011 and returns and recirculates the water to the main stream 101 at point 1019. It is noteworthy that, in the embodiment shown in FIG. 1, the return point 1019 is upstream of the entrance point 1011. This creates a feedback system of the water stream. When the water in substream 110 re-enters the main stream 101, the main stream 101 dilutes the monochloramine generated. Hence, all of the sensors in the substream 110 may monitor the system's 100 own monochloramine status through this arrangement. While this particular arrangement is show in FIG. 1, those skilled in the art will understand that the embodiments of the invention are not limited to this particular arrangement.

At one point of the main stream 101, a flow measuring device, such as a flow meter 103, is present to measure the total flow rate of the main stream 101. The flow meter 103 can be wired to or wirelessly connected to the controller 111. Those skilled in the art will understand that many types of flow meters can be used for this purpose. In one embodiment, a clamp-on ultrasonic flow meter or a magnetic inline flow mater is used as the flow meter 103. In another embodiment, an electromagnetic flow meter is used as the flow meter 103. In yet another embodiment, a flow measuring device utilizes a pressure transducer, which is based on analyzing the changing pressure during the discharge stroke of the pump is used. Also, those skilled in the art will understand that the placement of the flow meter 103 is not limited to the one shown in FIG. 1. The flow meter 103 can be placed before the point 1019, between the points 1019 and 1011, or after the point 1011.

Now referring to the side stream 102, it further comprises a first substream 110 and a second substream 150. Water enters the side steam 102 at point 1011. The water is then separated into two streams at a tee 104 into the first substream 110 and the second substream 150.

With respect to the first substream 110, the monochloramine water disinfection system comprises multiple tees, a thermal flow switch 112, an oxidation-reduction potential (ORP) sensor 114, a free chlorine sensor 116, a pressure transmitter 120, a flow meter 122, an elbow 124, a chlorine pump 126, an ammonia pump 128, a mixer 130, a sample valve 132, and a programmable controller 111.

When water enters the first substream 110 through tee 104, the water first passes through a thermal flow switch 112 at a tee 1120. The thermal flow switch 112 monitors the water flow to ensure the water flow is within a reasonable range. The thermal flow switch 112 is connected to the controller 111. When the water flow is outside a predetermined safety range, the thermal flow switch 112 will send a warning signal to the controller 111 or will show a visual warning indication on a monitor panel or send a warning message to a remote device, such as via electronic communications such as emails, SMS or other instant messengers. The thermal flow switch 112 may also serve to limit the flow rate of the water stream to protect various sensors, such as the free chlorine sensor 116, since those sensors usually only function properly in a particular range of flow rate and an excessive flow rate may damage the sensors, such as their membrane.

The water then passes through an ORP sensor 114 at tee 1140. The ORP sensor 114 detects the oxidation potential, usually in millivolts, mV, of the water stream. The ORP sensor 114 provides a quick measurement of the oxidation potential of a water stream because typical ORP sensors are usually fully automatic and provide instantaneous readings to the user. The ORP sensor 114 continuously detects the oxidation potential of the water stream in the first substream 110 and sends its detected data to the controller 111 for further analysis.

The ORP sensor 114 serves two general purposes in the monochloramine water disinfection system. First, it provides an indication of disinfection level in the water. A water stream with a low oxidation potential, such as in a range from 0 to 150 mV, usually indicates that the water is contaminated because a low oxidation potential is a sign that the dissolved oxygen in the water stream is consumed by foreign contaminants such as microbes. Chlorine and monochloramine are strong oxidizing agents. As such, any chlorine chemicals in a water disinfection system will dominantly control the oxidation potential of the water stream. The presence of a small threshold concentration of chlorine and monochloramine will bring a water sample's oxidation potential to about 450-500 mV.

The water supplied by a municipal water system may have sufficient chlorine disinfectant at the point of entry into the domestic water system. However, as water travels through complex pipes, apparatus, and sub-systems, chlorine or monochloramine can be consumed or degraded. As the embodiments of the present invention are often targeted at distal-ends water supply systems, where the chlorine disinfectants are often significantly depleted, the ORP sensor 114 provides an indication of the presence of chlorine and the contamination of the water stream in the first substream.

Another purpose of the ORP sensor 114 is to detect the presence of dichloramine. Dichloramine has an oxidation potential of around 650-700 mV. The presence of a small threshold amount of dichloramine will increase the oxidation potential detected by the ORP sensor 114 to such a level. To remove the dichloramine in the water stream, the controller 111 will direct the ammonia pump 128 to increase the amount of ammonia injected into the subsystem 110 according to a programmed algorithm as discussed in further details below.

Still referring to FIG. 1 and substream 110, after the tee 1140, the water stream then reaches a free chlorine sensor 116 at a tee 1160. Free chlorine denotes free active chlorine, such as any unreacted free chlorine molecules, Cl₂, or chemical equivalence of chlorine molecules, such as hypochlorous acid, HOCl, and hypochlorite ions, OCl⁻, in the water stream. The free chlorine sensor 116 detects the concentration of free active chlorine. Like the ORP sensor 114, the free chlorine sensor 116 is also connected to the controller 111. In some embodiments of the present invention, the free chlorine sensor performs automatic and instantaneous detection of free chlorine levels without the assistance of the operator. This avoids the need for a building manager of a residential or commercial complex to conduct a manual chemical analysis, such as a DPD test. Preferably, the free chlorine sensor does not require the addition of any chemical reagents to detect the level of free chlorine. Hence, once calibrated, the free chlorine sensor 116 allows the controller 111 to monitor the free chlorine level in real time and calculate the amount of ammonia and chlorine required to supply to the first substream 110 according to a programmed algorithm as discussed in further details below. The free chlorine sensor may measure the amount of free chlorine in parts per million (ppm) or in milligrams per liter (mg/l).

Now referring to the second substream 150, a total chlorine sensor 158 is installed at tee 1580. Total chlorine denotes the sum of free chlorine and combined chlorine. Combined chlorine is the reaction product of active chlorine and nitric chemicals such as ammonia or organic nitrogen. Examples of combined chlorine includes monochloramine, dichloramine, trichloramine, and other organic chloramine. The selection criteria for the total chlorine sensor 158 is similar to those of the free chlorine sensor 116. Preferably, the total chlorine sensor 158 should be automatic and should not require any addition of chemical reagents or manual chemical testing for the detection of total chlorine. The total chlorine sensor 158 is also electrically connected to the controller 111. Although the free chlorine sensor 116 and the total chlorine sensor 158 are located in different substreams, the composition of the first and second substreams 110 and 150 should be the same at tees 1160 and 1580 because the two substreams 110 and 150 originate from the same stream and are merely separated at tee 104.

For some total chlorine sensors, they are sensitive to pressure and temperature. Their functionality in high temperature or high pressure is sometimes severely limited and adversely affected. Hence, in some preferred embodiments, the water in the side stream 102 is further separated into substreams 110 and 150. The total chlorine sensor 158 is installed specifically in another substream, separating the total chlorine sensor 158 from other sensors. When the water enters substream 150, it first passes through two temperature transmitters 152 and 154 for heat exchange. The temperature transmitters could be heaters or coolers. The two temperature transmitters 152 and 154 controls the temperature and the pressure of the substream 150 to ensure the total chlorine sensor 158 can be properly functioned. The needle valve 156 also roughly controls the flow rate of the substream 150.

Owing to the potential complex piping and water circulating in the water disinfection subsystem, there might not be sufficient water pressure for the water stream in the water disinfection side stream. Referring back to first substream 110, after various readings are taken, such as ORP, free chlorine amount, and total chlorine amount, a pressure transmitter 120 such as a boost pump is installed at a tee 1200 to increase the water pressure in the subsystem 110. Thus, if the water stream has insufficient pressure difference between the intake point and return point, the pressure transmitter 120 is used to increase the pressure of the water stream.

Still referring to substream 110, after the water stream passes through the tee 1200, then a flow meter 122 is present to measure the flow rate of the substream 110. The flow meter 122 is present as a safety mechanism to ensure some water is flowing in substream 110. Zero and low reading of the flow meter 122 indicates insufficient water flow in the substream 110. In such situations the controller 111 will direct the pressure transmitter 120 to increase the pressure of the water stream or shut down the system entirely when no water is flowing. The controller 111 will show a visual warning indication on a monitor panel or send a warning message to a remote device, such as via electronic communications such as emails, SMS or other instant messengers.

The controller 111 utilizes an algorithm, which will be discussed in a greater detail below, to calculate the amount of ammonium sulfate and the amount of sodium hypochlorite required to generate a desirable amount of monochloramine. The desirable amount of monochloramine is set by the operator of the water disinfection system, such as the building manager or the provider of the system 100, who remotely operates the system. The controller 111 controls the chlorine pump 126 and the ammonia pump 128 to inject ammonium sulfate and sodium hypochlorite into the water stream. The chlorine pump 126 comprises a storage tank 1262, a flow cell 1264, and an inline flow meter 1266 within the flow cell 1264. The storage tank 1262 stores the aqueous solution of sodium hypochlorite at a known concentration, which is determined by the operator of the water disinfection system. The flow cell 1264 controls the feed rate of sodium hypochlorite solution injected into the water disinfection system through the inline flow meter 1266. Once the operator of the system inputs the concentration of sodium hypochlorite into the controller 111, the controller 111 can determine the amount of sodium hypochlorite required to be injected and control the flow cell 1264. Sodium hypochlorite is injected in the water stream at the chlorine pump injection point at a tee 1260.

The design of the ammonia pump 128 is very similar to the chlorine pump 126. The ammonia pump 128 also comprises a storage tank 1282, which stores ammonium sulfate at a know concentration; a flow cell 1284, which controls the feed rate of ammonium sulfate; and, an inline flow meter 1286 within the flow cell 1284, which controls the feed rate of ammonium sulfate. The ammonium sulfate is injected in the water stream at the ammonia injection point at a tee 1280.

After a controlled amount of sodium hypochlorite and ammonium sulfate are injected into the water stream, the added hypochlorite and ammonium ion are mixed in a mixer 130. In one embodiment, the mixer 130 is a static mixer that allows the hypochlorite and ammonium ion sufficient time to form monochloramine.

Before the water leaves the first substream 110 to return to the main water steam 101, it passes through a sample valve 132 at a tee 1320. The sample valve 132 allows the operator or other water treatment professionals to obtain samples of the water stream for further analyses such as performing chemical testing. While, in preferred embodiments, obtaining sample of the water stream is not required, preferably at least one sample valve 132 should be present in the system after the mixer 130 for occasional testing and calibration purposes. While not shown in FIG. 1, other sample valves can also be present in the water system at other locations such as before the chlorine pump 126 and the ammonia pump 128. While the controller 111 controls the generation of monochloramine automatically without the need of the building manager to monitor the water quality and the disinfection system constantly, the occasional testing of the water sample obtained from the sample valve 132 allows water treatment professionals to fine tune and calibrate the water disinfection system periodically.

After appropriate amount of monochloramine is made at mixer 130, the disinfecting chemicals with the side stream water re-enters the main stream 101 so now the main stream 101 is filled with appropriate level of monochloramine.

While the order, arrangement, and placement of different components in FIG. 1 are discussed above in accordance to a particular embodiment of the present invention, those skilled in the art will appreciate that the components are not limited to the particular order disclosed in the FIG. 1. For example, the positions of various sensors may be changed in different water disinfection systems.

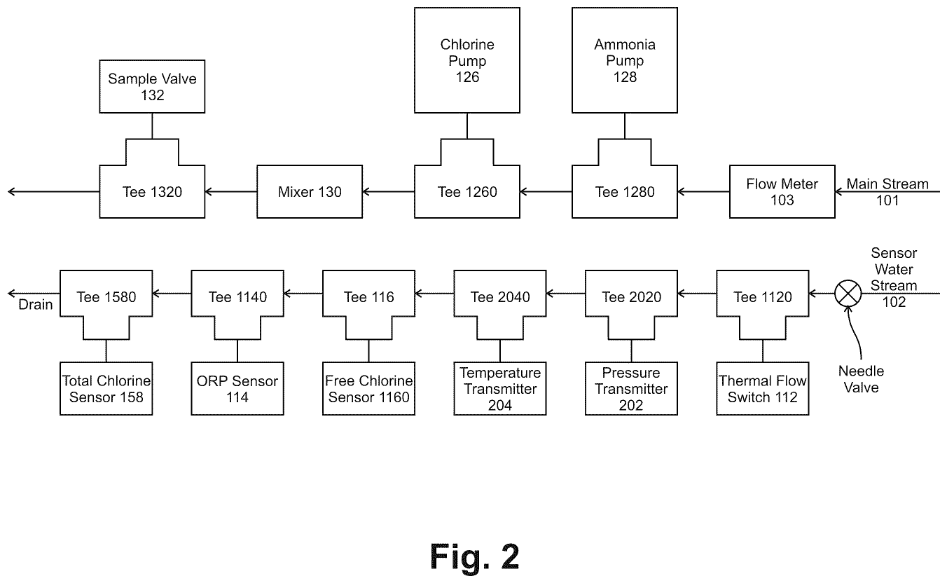

Now referring to FIG. 2, it is another embodiment of the distal end water disinfection system 100. The system also comprises a main carrier water stream 101 and a side stream 102. Similar to the system 100 shown in FIG. 1, the side stream 102 also diverges water from the main stream 101. However, instead of having chlorine and ammonia injected into the side stream and recirculating the side stream water containing monochloramine into the main stream, the system 100 shown in FIG. 2 injects chlorine and ammonia directly into the main stream 101 to generate monochloramine. The side stream 102 is now only for measurement and the water in the side stream 102 does not return to the main stream 101. Most sensors including thermal flow switch 112, free chlorine sensor 116, ORP sensor 114, and 158 are installed in the side stream 102. After measurements are taken and are sent to the controller 111 (not shown in FIG. 2), the water in side stream 102 goes directly to the drain instead of recirculating to the main stream 101. Pressure transmitter 202 and temperature transmitter 204 are present upstream of various sensors to protect the sensors by controlling the pressure and temperature of the water before the water passing the sensors. In the main stream 101, like the system in FIG. 1, a flow meter 103 is present to measure the total flow rate of the water stream. Since the embodiment shown in FIG. 2 does not require the recirculation of the water in the side stream 102, it is particularly suitable for further downstream in any water system.

Again, while the order, arrangement, and placement of different components in FIG. 2 are discussed above in accordance with a particular embodiment of the present invention, those skilled in the art will appreciate that the components are not limited to the particular order disclosed in the FIG. 2.

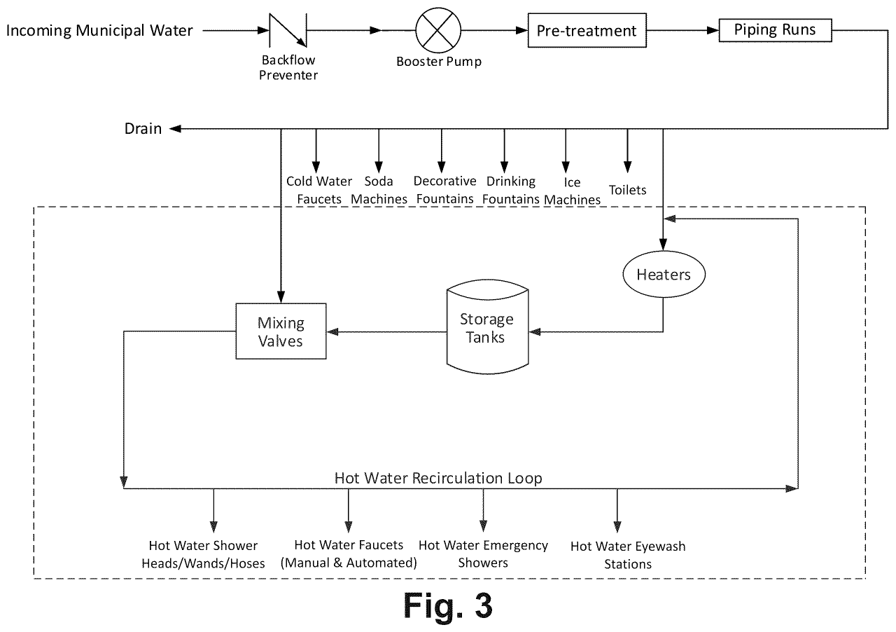

Now referring to FIG. 3, the disinfection apparatus or system disclosed according to the embodiments of the present invention can be installed in various locations in a domestic water system. For example, the apparatus may take a side stream of water after the pressure booster pump, generate monochloramine in the side stream, and recirculate the side stream with monochloramine back into the main stream. This stream of water is returned to the domestic water system at a point after the boost pump. If there is not enough pressure difference between the intake point and return point, the side stream is pumped back to the main water system with a boost pump, such as the pressure transmitter 120, provided by the apparatus. The disinfection apparatus can also be installed at any locations in FIG. 3. The automatic regulation and generation feature of the embodied apparatus provides the flexibility for the apparatus to be installed in almost any water supply system.

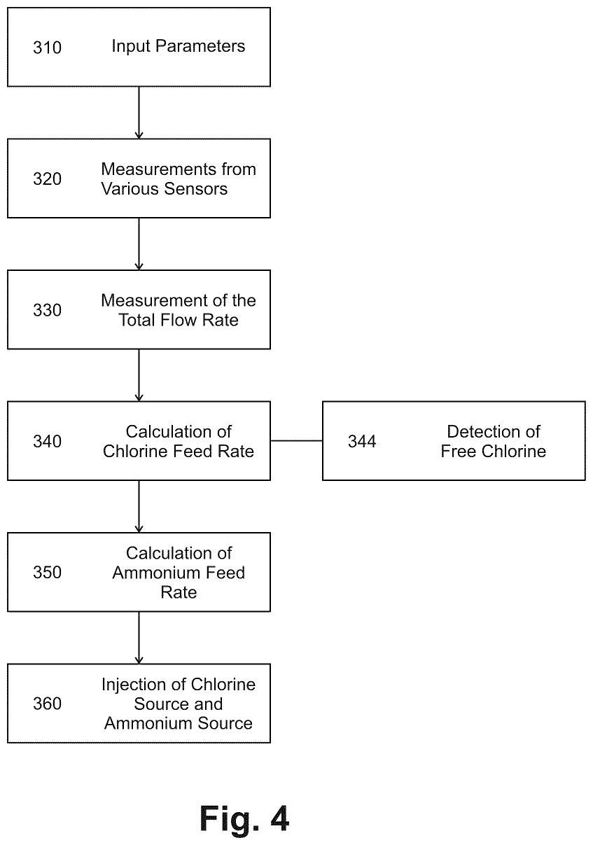

Now referring to FIG. 4, it is an exemplified flowchart of the operating program or algorithm of the controller 111 in accordance with some embodiments of the present invention. The controller 111 suitable for the embodiments of the present invention includes any system that contains a microprocessor that can be programmed, such as a programmable logic controller (PLC). The programmable controller 111 could also be a computer that has an operating system and is equipped with a digital and analog input/output module.

Prior to step 310, the controller 111 is electrically connected to the various components of the water disinfection system. The controller 111 reads analog or digital information from the sensors and the flow meter 103. The controller 111 also sends actuation control signals to various valves and pumps, such as the pressure transmitter 120, chlorine pump 126 and ammonia pump 128. The controller 111 has an interface where an operator can input control parameters to the controller 111. An operator can be the provider of the system 100, who operates the system remotely, or the building manager. The controller 111 can communicate with a system that is located remotely. All operations that can be performed locally at the system 100 can also be performed remotely via electronic communications.

Step 310 represents the preparation and set up stage of the controller 111. Prior to step 310, an embodiment of the invention is installed within a water supply system. The operator then stores sodium hypochlorite solution of a known concentration in the storage tank 1262 of the chlorine pump 126 and stores ammonium sulfate in the storage tank 1282 of the ammonia pump 128. In some preferred embodiments, the storage tanks 1262 and 1282 include volume sensors that send signals to the controller 111 when the volume of the solution in the storage tank is below a certain level. When the controller 111 receives such signals, it will provide a visual or audio warning to remind the operator to refill the reactant chemicals.

The controller 111 has a user interface in accept different input control parameters. After the storage tanks are filled, the operator can then input the concentration of sodium hypochlorite and the concentration of ammonium sulfate to the controller 111 through its interface. The operator at step 310 also sets the target monochloramine concentration and the target chlorine to ammonium molar ratio. In some embodiments, the amount of monochloramine that the water disinfection system will generate through the reaction of hypochlorite and ammonium sulfate is based on the water flow, the target monochloramine concentration, the target chlorine to ammonium molar ratio and the hypochlorite concentration. The operator can change the data values inputted at this step any time in the future. For example, the operator can increase the desired concentration of monochloramine in the water stream by simply increasing the target monochloramine concentration value. Similarly, if the operator purchases a new solution of sodium hypochlorite, he can adjust the concentration value stored in the controller 111 based on the concentration of the new solution.

At step 320, water begins to enter the disinfection stream and the controller 111 begins to receive signals from various sensors of the water disinfection system. The controller 111 records and analyzes the oxidation potential, the free chlorine amount and the total chlorine amount detected from various sensors. At step 330, the controller 111 receives signals from flow meter 103 for the total flow rate of the main water stream 101. The data value of the total flow rate of the water stream is usually in volume per time, such as gallon per minute or milliliter per second, although other types of measurement unit can also be used. The type of measuring unit for the total flow rate would depend on the type of flow meter 103. For example, an ultrasonic flow meter measures the flow rate in volume per time.

At step 340, the controller performs calculations based on various inputted data and readings obtained from the previous steps to determine the desired input feed rate of sodium hypochlorite to achieve the target monochloramine concentration set at step 310. In addition, the controller 111 also monitors and records the reading of various sensors. In some preferred embodiments, the controller 111 records its data and transmit data logs periodically to the remote operator via electronic communication, such as such as e-mail, SMS, and any forms of instant messaging.

In some embodiments, the required feed rate of sodium hypochlorite is correlated with a proportional coefficient of sodium hypochlorite to the main water flow rate. Proportional coefficient of a chemical here denotes the ratio of the flow volume of the solution of the chemical to the total flow volume of the water stream. For example, if the proportional coefficient of sodium hypochlorite required to achieve a target monochloramine concentration of 6 parts per million, ppm, is 0.2, it means that the required feed rate of sodium hypochlorite to generate 6 ppm of chlorine in the form of monochloramine will be 2 units per second for each 10 units per second of total water flow rate measured by the flow meter 103.

At step 340, the controller calculates the proportional coefficient of sodium hypochlorite based on an algorithm using the target monochloramine concentration inputted at step 310, the concentration of sodium hypochlorite inputted at step 310, the total flow rate of water stream measure by the flow meter 103, and other data and readings. While a method of calculation will be discussed in a greater detail in accordance with some embodiments of the present invention, those skilled in the art will understand that other calculations to arrive at the proper monochloramine concentration are possible. In one embodiment, the flow meter 103 is an ultrasonic flow meter and measures the total water flow rate in volume per minute. Since the volumetric flow rate of the water stream is known, the controller 111 calculates the rate of required generation of the monochloramine based on the volumetric flow rate of the water stream and the specific gravity of the water stream. For water in domestic water system, the water can be assumed to be relatively free of heavy contaminants and, thus, the specific gravity of the water stream can be assumed to be 1 g/ml. Thus, the controller 111 can convert the volumetric flow rate of the water stream to mass flow rate. Then the controller 111 determines the required rate of generation of monochloramine based on the inputted ppm, i.e. weight per millions of weight of the water stream. While the inputted ppm is usually expressed as the target amount of monochloramine, it sometimes in fact represents the amount of equivalent chlorine in the form of monochloramine. Since the stoichiometric ratio of hypochlorite to monochloramine, according to the chemical equations that represent the generation of monochloramine, is 1:1, the controller 111 then determines the required amount of hypochlorite. The controller then calculates the required volumetric feed rate of sodium hypochlorite and determines the proportional coefficient of sodium hypochlorite. At step 360, the controller 111 commands the chlorine pump 126 to inject sodium hypochlorite into the water stream based on the calculated volumetric feed rate of sodium hypochlorite.

At step 350, the controller 111 calculates the required volumetric feed rate of ammonium sulfate. The method of calculation is very similar to that of sodium hypochlorite. In some embodiments, in order to avoid the generation of dichloramine or trichloramine, the molar ratio of the chlorite and ammonium are kept stoichiometrically near 1 to 1 to avoid the chlorination breakpoint. The default stoichiometric ratio can be set at 1:1 or the operator of the system can manually set a preferable stoichiometric ratio. The feed rate of sodium hypochlorite and the feed rate of ammonium sulfate is regulated based on a predetermined ratio, which is usually the default stoichiometric ratio or the ratio set by the operator. The predetermined ratio could also be based on the stoichiometric ratio of chlorine and ammonium or other equivalent ratio. The feed rate of sodium hypochlorite is calculated according to the flow rate of the water stream to be treated. The feed rate of ammonium sulfate is calculated based on the total water flow rate and the stoichiometric ratio to provide an amount of ammonium that is equivalent to the molar amount of active chlorine source in the water stream. The proportional coefficient of ammonium sulfate is also calculated similarly.

The operator can also set alarm limits for various sensors, such as the ORP sensor, the free chlorine sensor and the total chlorine sensor. If any one of these limits is exceeded, an alarm is generated and both feed pumps 126 and 128 are disabled until all of the sensor values are returned below their respective high limit. Warning signals are also sent to the operator. Hence, the maximum chlorine feed rate can be limited by monitoring the free chlorine amount in the water stream by the free chlorine sensor 116, or by monitor the total chlorine amount in the water stream by the total chlorine sensor 158.

While the controller 111 disclosed here performs the calculation of the feed rate of sodium hypochlorite first at step 340, then calculates the feed rate of the ammonium sulfate source second at step 350, those skilled in the art will appreciate that the step 350 can also be performed first before step 340. The feed rate of the ammonium sulfate source can be calculated first based on the total water flow rate. The feed rate of sodium hypochlorite can then be calculated either based on the total water flow rate or on the stoichiometric ratio using the feed rate of the ammonium sulfate. The feed rate of sodium hypochlorite and the feed rate of ammonium sulfate again can be regulated based on a predetermined ratio.

The following is an exemplary calculation using actual numbers. The numbers are for illustrative purpose only and shall not be construed as limiting the scope of the invention. For example, the operator sets target monochloramine concentration to 4 ppm of chlorine in the form of monochloramine. Thus, at step 310, the operator inputs 4 ppm as the target monochloramine concentration. The operator also knows that the sodium hypochlorite concentration in storage tank 1262 is 10% weight per volume. The flow meter 103 determines that the total water flow rate of the main stream 101 is 1000 gallon per minute. The controller 111 first converts 1000 gal/min into liter per min by multiplying 1000 gal/min to the liter to gallon ratio, i.e. 3.785 L/gal. The result is 3785 L/min. For each part per million of target monochloramine concentration, it requires one milligram of chlorine in the form of monochloramine per each kilogram of water. Since the density of water equals to 1 kilogram per liter, 3785 L/min means that there are 3785 kilograms of water per minute passing through tee 1220. As 4 ppm of chlorine in the form of monochloramine is required, the required sodium hypochlorite is 3785 kilograms per minute times 4, which is 15140 milligrams per minute.

The specific gravity of sodium hypochlorite in low concentration is also 1 g/ml, or 1000 mg/ml. Thus, to achieve the target monochloramine concentration, it requires 15.14 mL per minute of a 100% sodium hypochlorite solution. As the concentration of sodium hypochlorite is only 10%, the required volumetric flow rate, or the feed rate, of sodium hypochlorite stored in the chlorine pump 126 is 151.4 mL/min. Since the total flow rate of the water stream is 3785 L/min, the proportional coefficient of sodium hypochlorite is 151.4/1000=0.1514 ml/gallon, meaning each gallon of water stream requires the feeding of 0.1514 ml of sodium hypochlorite into the water stream to generate the target 4 ppm of monochloramine.

The controller 111 similarly calculates the required feed rate of ammonia sulfate and its proportional coefficient. For example, at step 310, the operator knows that the concentration of ammonium sulfate in storage tank 1282 is 40% weight per volume and inputs the concentration to the controller 111. The controller 111 calculates at step 340 the required amount of ammonium sulfate based on a stoichiometric ratio of one hypochlorite to one ammonium as well as the molar weight ratio of sodium hypochlorite to ammonium sulfate. Using all these data, the controller 111 determines that 35.7 ml/min of ammonium sulfate is required and commands the ammonia pump 128 at step 360 to inject the calculated amount to the water stream.

In some embodiments, the proportional coefficients of sodium hypochlorite and ammonium sulfate are calculated by a person, for example, the installer of the system or the provider of the system based on the concentration of sodium hypochlorite and ammonium sulfate. The calculated proportional coefficients are then inputted to the controller 111 through its interface. Now the controller 111 is only required to measure the total water flow rate through the flow meter 103 to determine the feed rate of sodium hypochlorite and ammonium sulfate because the proportional coefficients are known to the controller 111. This would further simplify the system. Operators can also control the feed rate of sodium hypochlorite and ammonium sulfate by simply adjusting the inputted value of proportional coefficients. Hence, the feed rates can be based on the adjustable proportional coefficients. For example, if the operator wants to increase the feed rate of sodium hypochlorite, he can increase the inputted value of the proportional coefficient of sodium hypochlorite.

In some embodiments, free chlorine residual is detected in the water stream at tee 1160 by the free chlorine sensor 116. This means the water stream contains a small amount of chlorine, probably generated in the municipal water disinfection system, when the water stream arrives at the domestic water system. In some embodiments, based on the data from the free chlorine sensor 116, the controller 111 determines if free chlorine is present. If free chlorine is present, the controller 111 enters another algorithm to determine the required feed rates for sodium hypochlorite. At step 344, the controller 111 detects the amount of free chlorine by the free chlorine sensor 116. The controller 111 then subtracts the calculated chlorine feed rate determined at step 340 by the amount of free chlorine. The adjusted chlorine feed rate will be sent to the chlorine pump 126 at step 360. In some embodiments, the feed rate of ammonium sulfate is unaffected by the presence of free chlorine. The feed rate of ammonium sulfate is calculated based on a stoichiometric ratio of one ammonium to one total amount of free chlorine, including the free chlorine originally present and the free chlorine added by the chlorine pump 126.

Another goal of the embodiments of the present invention is to prevent any unintended chemicals from forming. Monochloramine is the dominant product when hypochlorite and ammonium are reacted at a 1:1 ratio. However, when the ratio of chlorine to ammonium increases to 2:1 or even 3:1, dichloramine and trichloramine begin to form and become the dominating products. Thus, the amount of chlorine is closely monitored by the total chlorine sensor 158, the free chlorine sensors 116, and the ORP sensor 114. The amount of free chlorine in the stream is limited to prevent the buildup of any dichloramine and trichloramine. When a large amount of free chlorine is present, the controller 111 may stop or reduce the feeding of the hypochlorite from the chlorine pump 126 and/or increase the feeding of ammonium sulfate from the ammonia pump 128. In those situations, the controller provides an appropriate visual or audio indication to the operator to indicate the problem and/or transmit remote warning alerts to the operator via electronic communication, such as e-mail, SMS, and any forms of instant messaging.

In some embodiments, the controller 111 is programmable to adjust the proportional coefficients of sodium hypochlorite and ammonium sulfate. In a complex domestic water piping system in a building or a group of buildings, it is sometimes not necessary to maintain a constant level of monochloramine through out the system. One embodiment of the invention is to maintain the minimal amount of monochloramine required for effectively disinfecting at the distal ends and yet not to exceed the maximum amount of monochloramine allowed by the regulatory authorities at any locations in the treated water system. The target monochloramine concentration set up in the controller 111 should be set closer to the maximum value of the monochloramine concentration that can be detected in the system.

For example, if the target monochloramine concentration set in the controller 111 at step 410 is 3.0 ppm, the concentration of monochloramine in a sample taken from a point of use closest to the monochloramine injection point at around mixer 130 could be 2.5 ppm. Owing to the depletion of monochloramine, the concentration in a sample taken from the most distal end could be reduced to 1.5 ppm. If one wishes to maintain 2 ppm monochloramine at the most distal end, then the operator should increase the setup concentration to 4.0 ppm by adjusting the proportional coefficient of sodium hypochlorite and ammonium sulfate. Hence, in some embodiments, the feed rates of sodium hypochlorite and ammonium sulfate can be calculated stoichiometrically according to measured total water flow rate and a maximum total chlorine or monochloramine concentration allowed in the water stream.

At step 360, the controller 111 controls the feed rate of sodium hypochlorite and ammonium sulfate solution based on the feed rates determined in the previous steps. Both the chlorine pump 126 and the ammonia pump 128 are equipped with or associated with an inline flow meter 1266 and 1286 respectively. The flow meter can be set up to receive a 4-20 mA current control signal from the controller 111 and make the current control signal be proportional to flow rate of the chemical. The flow meter reads the actual flow rate of the chemical and transmits the flow rate in the form of electrical signal. The flow meter also has an internal feedback control mechanism to achieve the target feed rate according to the determined feed rate by the controller 111.

The controller 111 first directs the chlorine pump 126 to inject sodium hypochlorite into the water system. Once the sodium hypochlorite solution begins to flow through the inline flow meter 1266, the inline flow meter 1266 begins to measure the flow rate of sodium hypochlorite and transmits the flow rate in the form of current to the controller 111. After the controller 111 receives a reading of the flow rate of sodium hypochlorite, it transmitting a control signal to the chlorine pump 126 to adjust the power of the chlorine pump 126 until the flow rate measured by the inline flow meter 1266 matches the feed rate calculated at step 340. The control of the injection of ammonium sulfate is very similar to that of sodium hypochlorite.

In some embodiments, the invention can detect abnormal conditions. For example, if the flow meters 1266 or 1286 read a low or zero flow rate of either sodium hypochlorite or ammonium sulfate even though the controller 111 commands the chlorine pump 126 or the ammonia pump 128 to inject at a significantly higher value, then the low reading of the flow meters 1266 or 1286 indicate that the corresponding storage tank 1262 or 1282 is out of the reactant chemical. If one of the reactant chemicals in the storage tanks 1262 or 1282 is exhausted, the controller 111 is programmable to stop the monochloramine generation system until the operator replenishes the reactant chemical.

Also, the controller 111 compare the target amount of chemical used, such as the target use rate, to the actual amount of chemical used, such as the actual use rate, based on the data from the tank 1282 and pump 126 or 128. The target pump flow rate and the actual pump flow rate are continuously monitored. The target amount of chemicals that are supposed to be used is compared to the actual amounts of chemicals consumed, which are calculated from tank level sensor data. A significant difference in these values indicates an abnormality. Those skilled in the art will understand what constitutes a significant difference that warrants a warning.

The controller 111 also compares the actual chemical pump output flow rate to the calculated target output flow rate to detect whether the difference between the two values exceeds a pre-set tolerance level. If the actual pump output flow rate is significantly less than the target required output flow rate, it usually indicates a loss of prime. In this case the controller 111 will signal the pump to initiate a re-priming sequence. If the pump does not re-prime within a predetermined time limit, an alarm message will be sent indicating operator intervention is required. If the actual pump output flow rate is significantly higher than target flow rate required, it usually indicates other faulty pump operations. These faulty pump operations include pump being left in manual mode, syphoning conditions, tubing failure, manual priming valve left open, etc. This condition will also send an alarm indicating operator intervention is required.

Since the reactant chemicals should be injected at a stoichiometric ratio of approximately 1:1, the controller 111 will stop the injection of another chemical when it detects that one chemical is depleted. Unless the controller 111 determine that a stoichiometric ratio of 1:1 can be achieved, the controller 111 can be programmed to shut off the whole system to prevent the accumulation of any unintended chemical in the water stream and can provide warning locally or remotely accordingly.

There are several situations where the pump may not be able to achieve the target feed rate. A common one is that gas bubbles trapped in either the suction or the discharge side of the pump head causes the pump to lose prime. If this happens, the controller 111 should detect an abnormality from the flow meter 1266 or 1286. The controller 111 will then provide a visual or audio indication, such as sending an alarm message to the operator or sending a warning message to a remote device. In the case where no flow rate is detected, the controller can be programmed to simply shut off the whole system. The controller 111 is also capable of determining the flow ratio of two pumps and stopping feeding sodium hypochlorite and ammonium solution when the measured ratio is outside a pre-determined range.

Once the concentration of monochloramine is set at step 310, the concentration of the monochloramine can be periodically monitored and calibrated by using the free chlorine sensor and the total chlorine sensor. The embodiments of the present invention control the amount of monochloramine by controlling the amount of chlorine and ammonium supplied by a stoichiometric ratio of 1:1. By limiting the level of free chlorine, the formation of any dichloramine and trichloramine can be prevented. Since the original supply of chlorine and ammonium is in a stoichiometric ratio of 1:1 and since only monochloramine should be formed, ideally each chlorine supplied will react with each ammonium supplied to form a monochloramine molecule. Thus, when the free chlorine senor shows a reading in a close proximity to zero, it means that most, if not all, of the chlorine has reacted to form monochloramine. In this scenario, the total chlorine concentration equals the monochloramine concentration. Under these conditions, the controller 111 will continue the monochloramine generation process by the steps described in FIG. 4.

However, if other side reactions occur, the free chlorine could be detected or the total chlorine level will be different from the total monochloramine level. The total monochloramine level can be determined by obtaining a water sample at sample valve 132. Thus, by merely monitoring the value of free chlorine and the value of total chlorine or the oxidation potential, the controller 111 determines whether other side reactions occur. If the controller 111 determines any abnormality of the system, it will provide a visual or audio indication to the operator, such as providing a warning message to the operator or sending a warning message to a remote device. The operator can then contact water treatment professional to re-calibrate the system.

In preferred embodiments of the present invention, the water disinfection system does not include any sensor to monitor the level of ammonium or the level of monochloramine in the water stream. There are currently no reliable monochloramine sensors or user-friendly ammonia sensors known in the art that would permit the controller 111 to automatically calibrate ammonia levels. Any design with the requirement of detecting ammonia or monochloramine would require the operator to conduct manual chemical testing, which is not desirable to be used in a residential or commercial water system. While the embodiments of the present invention may be calibrated occasionally by conducting offline measurement using the water sample taken at sample valve 132, the embodiments do not require the detection of ammonia or monochloramine levels to operate properly.

In some embodiments, while the controller 111 is electrically connected to the sensors, meters and the water stream system, the controller 111 can communicate remotely to the operator. The operator can control the water disinfection system and adjust the parameters remotely. For example, in some embodiments the building manager can change the parameters of the controller 111 on site in the residential or commercial building. Yet, in other embodiments the controller 111 is located remotely or is connected to another controller at the office of the provider of the water disinfection system. Hence, the water treatment professional of the provider of the water disinfection system can control the system remotely from their offices.

The controller 111 provides a comprehensive warning system. If any such of the abovementioned abnormalities or problems is detected or any of the detected value from any sensor is outside its corresponding warning limit, the controller 111 an appropriate visual or audio indication to the operator to indicate the problem and/or transmit remote warning alerts to the operator via electronic communication, such as e-mail, SMS, and any forms of instant messaging. The controller 111 could also be programmed to automatically shut down the production of monochloramine production if any of the detected value is outside its corresponding warning limit. Production will restart automatically when the values return to normal. The controller 111 will also send a critical alarm message, such as via email, and remove power from all actuators when a leak is detected or when temperature or pressure is out of limits. In those situations, the controller 111 can be programmed so that the machine remains shut down until an operator determines the cause of the problems, corrects the alerted condition, and manually restarts the system 100.

In the foregoing description, while sodium hypochlorite and ammonium sulfate are used as the exemplary precursor chemicals to generate monochloramine, the scope of the present invention shall not be limited by the particular species of precursor chemicals disclosed here. For example, any chlorine source can be used in place of sodium hypochlorite. Common chlorine precursor chemicals in generating monochloramine include, but are not limited to, chlorine gas, chlorine solution, any hypochlorite solution, hypochlorous acid, and sodium hypochlorite. Similarly, any ammonium source can be used in place of ammonium sulfate. Common ammonia precursor chemicals in generating monochloramine include ammonia and any ammonium solution.

The foregoing description of the embodiments of the present invention has been presented for the purpose of illustration and description. It is not intended to be exhaustive or to limit the invention to the precise form disclosed. Many modifications and variations are possible in light of the above teachings. The numerical values described in the description are only for illustration purpose and should not be understood as limiting the invention to the precise numbers. It is intended that the scope of the present invention not be limited by this detailed description, but by the claims and the equivalents to the claims appended hereto.

I claim:

1. A method for generating monochloramine in a water stream by injecting a chlorine source and an ammonium source into the water stream, the method comprising the steps of:
measuring the total water flow rate of the water stream;
based on the total water flow rate, calculating a chlorine feed rate of the chlorine source;
based on the total water flow rate, calculating an ammonium feed rate of the ammonium source;
injecting the chlorine source into the water stream based on the chlorine feed rate; and
injecting the ammonium source into the water stream based on the ammonium feed rate.

2. The method of claim 1, further comprising:
maintaining the chlorine feed rate and the ammonium feed rate based on a predetermined ratio.

3. The method of claim 1, further comprising:
monitoring a free chlorine amount in the water stream by a free chlorine sensor; and limiting a maximum chlorine feed rate by the free chlorine sensor.

4. The method of claim 1, further comprising:
monitoring a total chlorine amount in the water stream by a total chlorine sensor; and limiting a maximum chlorine feed rate by the total chlorine sensor.

5. The method of claim 1, further comprising:
monitoring an oxidation potential in the water stream by an oxidation reduction potential sensor.

6. The method of claim 1, wherein the calculation of the chlorine feed rate is further based on a proportional coefficient of the chlorine source to the total water flow rate.

7. The method of claim 1, wherein the calculation of the ammonium feed rate is further based on a proportional coefficient of the ammonium source to the total water flow rate.

8. The method of claim 2, wherein the predetermined ratio is based on a predetermined stoichiometric ratio.

9. The method of claim 8, wherein the predetermined stoichiometric ratio is a stoichiometric ratio of chlorine to ammonium substantially equals to 1:1.

10. A method for generating monochloramine in a water stream, the method comprising the steps of:
measuring a total water flow rate from a main flow measuring device that is connected to the water stream;
based on the total water flow rate, calculating a chlorine feed rate of a chlorine source;
based on the total water flow rate, calculating an ammonium feed rate of an ammonium source;
utilizing a chlorine pump being connected to the water stream to inject the chlorine source into the water stream; the chlorine pump is associated with a first side flow measuring device; the first side flow measuring device is capable of measuring a flow rate of the chlorine source passing through the first flow measuring device;
measuring the flow rate of the chlorine source from the first side flow measuring device and controlling the flow rate of the chlorine source of the chlorine pump based on the calculated chlorine feed rate;
utilizing an ammonia pump being connected to the water stream to inject the ammonium source into the water stream to react with the chlorine source injected; the ammonia pump is associated with a second side flow measuring device; the second side flow measuring device is capable of measuring a flow rate of the ammonium source passing through the second side flow measuring device;
measuring the flow rate of the ammonium source from the second side flow measuring device and controlling the flow rate of the ammonium source of the ammonium pump based on the calculated ammonium feed rate;
and maintaining a ratio of the chlorine feed rate to the ammonium feed rate based on a predetermined ratio.

11. The method of claim 10, wherein any of the flow measuring devices utilizes an inline magnetic flow meter.

12. The method of claim 10, wherein any of the flow measuring devices utilizes a pressure transducer, which calculates the flow rate by analyzing a changing pressure during a discharge stroke.

13. The method of claim 10, where the calculation of the chlorine feed rate is further based on a proportional coefficient of the chlorine source to the total water flow rate and the chlorine feed rate can be controlled by adjusting the proportional coefficient of the chlorine source.

14. The method of claim 10, where the calculation of the ammonium feed rate is further based on a proportional coefficient of the ammonium source to the total water flow rate and the ammonium feed rate can be controlled by adjusting the proportional coefficient of the ammonium source.

15. The method of claim 10, wherein the predetermined ratio is based on a predetermined stoichiometric ratio.
